(19) United States
(12) Patent Application Publication
(10) Pub. No.: US 2024/0320444 A1
(43) Pub. Date: Sep. 26, 2024

(54) USER INTERFACE FOR AI-GUIDED CONTENT GENERATION

(71) Applicant: Shopify Inc., Ottawa (CA)

(72) Inventors: Russ MASCHMEYER, Berkeley, CA (US); Daniel BEAUCHAMP, Toronto (CA)

(73) Assignee: Shopify Inc., Ottawa, ON (CA)

(21) Appl. No.: 18/467,781

(22) Filed: Sep. 15, 2023

Related U.S. Application Data
(60) Provisional application No. 63/491,321, filed on Mar. 21, 2023.
(60) Provisional application No. 63/501,526, filed on May 11, 2023.

(51) Int. Cl. G06F 40/40; G06F 3/0482; G06F 40/166; G06F 40/284

(52) U.S. Cl. CPC G06F 40/40; G06F 3/0482; G06F 40/166; G06F 40/284; G06F 3/0486

(57) ABSTRACT

A computer-implemented method is disclosed. The method includes: obtaining at least one output of a generative model based on input of a first text prompt; presenting the at least one output via a user interface; receiving, via the user interface, user selection of a desired portion of the at least one output; modifying the first text prompt based on the user selection to obtain a second text prompt; and providing the second text prompt as input to the generative model for obtaining a second output.

### TECHNICAL FIELD

The present disclosure relates to generative artificial intelligence (AI) models and, more particularly, to systems and methods for processing outputs of large language models (LLMs).

### BACKGROUND

Generative artificial intelligence models are increasingly being used across many domains to facilitate creation of new content. Such models (e.g., large language models, text-to-image models, etc.) can be used to generate detailed text or images conditioned on input of natural language prompts.

### BRIEF DESCRIPTION OF THE DRAWINGS

Reference will now be made, by way of example only, to the accompanying drawings which show example embodiments of the present application, and in which:

FIG. 1 illustrates, in block diagram form, an example system for implementing a content generation engine that leverages use of a generative AI model;

FIG. 2 shows, in flowchart form, an example method for customized content creation using a generative AI model;

FIG. 3 shows, in flowchart form, an example method of providing a user interface for customizing AI-generated content;

FIG. 4 shows, in flowchart form, another example method for customized content creation using a generative AI model;

FIGS. 5A-5C show pages of a graphical user interface that supports auto-generation of customized text content, in accordance with example embodiments;

FIGS. 6A-6C illustrate use of a sandbox for generating customized images, in accordance with example embodiments;

FIG. 7 is a block diagram of an example computing system, which may be used to implement examples of the present disclosure;

FIG. 8 is a block diagram of a simplified convolutional neural network, which may be used in examples of the present disclosure; and

FIG. 9 is a block diagram of a simplified transformer neural network, which may be used in examples of the present disclosure.

Like reference numerals are used in the drawings to denote like elements and features.

### DETAILED DESCRIPTION OF IMPLEMENTATIONS

In an aspect, the present application discloses a computer-implemented method. The method may include: obtaining at least one output of a generative model based on input of a first text prompt; presenting the at least one output via a user interface; receiving, via the user interface, user selection of a desired portion of the at least one output; modifying the first text prompt based on the user selection to obtain a second text prompt; and providing the second text prompt as input to the generative model for obtaining a second output.

In some implementations, the at least one output may include multiple different outputs generated via the generative model based on a same text prompt.

In some implementations, the generative model may be one of a text-to-image model or a large language model (LLM).

In some implementations, receiving the user selection of a desired portion may include: performing text processing of a text output for obtaining a list of one or more tokens; presenting the one or more tokens via the user interface; and receiving selection of at least one of the one or more tokens.

In some implementations, receiving the user selection of a desired portion may include: performing object detection of an image output for identifying one or more objects; graphically representing the one or more objects via the user interface; and receiving selection of at least one of the one or more objects.

In some implementations, the method may further include displaying, via the user interface, a sandbox region for graphically representing the user selection, wherein the sandbox region is dynamically updated based on selections of desired portions across multiple different outputs.

In some implementations, the method may further include: receiving, via the user interface, input for changing a property of a selected desired portion of the at least one output in the sandbox region; and updating the user interface to represent the inputted change of the property.

In some implementations, the property of the selected desired portion may comprise one of location, scale, color, or language.

In some implementations, the method may further include receiving, via the user interface, input of user edits of the at least one output and the second text prompt may be obtained by modifying the first text prompt based on the user selection and the user edits.

In some implementations, the user edits may comprise at least one of: deletion of a portion of an output; replacement of a portion of an output; or addition of text or image.

In some implementations, the method may further include receiving user input of an adherence weight value representing a desired level of adherence to the user selection, and the second text prompt and the adherence weight value may be provided as input to the generative model for obtaining the second output.

In another aspect, the present application discloses a computing system. The computing system includes a processor and a memory coupled to the processor. The memory stores computer-executable instructions that, when executed by the processor, may configure the processor to: obtain at least one output of a generative model based on input of a first text prompt; present the at least one output via a user interface; receive, via the user interface, user selection of a desired portion of the at least one output; modify the first text prompt based on the user selection to obtain a second text prompt; and provide the second text prompt as input to the generative model for obtaining a second output.

In another aspect, the present application discloses a non-transitory, processor-readable medium storing processor-executable instructions that, when executed by a processor, may cause the processor to: obtain at least one output of a generative model based on input of a first text prompt; present the at least one output via a user interface; receive, via the user interface, user selection of a desired portion of the at least one output; modify the first text prompt based on the user selection to obtain a second text prompt; and provide the second text prompt as input to the generative model for obtaining a second output.

Other example implementations of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

In the present application, the term “generative AI model” (or simply “generative model”) may be used to describe a machine learning model. A generative AI model may sometimes be referred to, or may use, a language learning model (LLM). A trained generative AI model may respond to an input prompt by generating an output or result, through interpreting the intent and context of the prompt. The output/result may comprise new content such as text, images, audio, and the like. The generative AI model may be implemented with constraints on the acceptable prompts. In some cases, this may include a prompt template. A prompt template may specify that prompts have a certain structure or constrained intents, or that acceptable prompts exclude certain classes of subject matter or intent, such as the production of results or outputs that are violent, pornographic, etc.

Significant advances have been made in recent years in generative AI models. Different implementations may be trained to create digital art, computer code, conversation text responses, or other types of outputs. Examples of generative AI models include Stable Diffusion by Stability AI Ltd., ChatGPT by OpenAI, DALL-E 2 by OpenAI, and GitHub CoPilot by GitHub and OpenAI. The models are typically trained using a large data set of training data. For instance, in the case of AI for generating images, the training data set may include a database of millions of images tagged with information regarding the contents, style, artist, context, or other data about the image or its manner of creation. The generative AI trained on such a data set is then able to take an input prompt in text form, which may include suggested topics, features, styles or other suggestions, and provide an output image that reflects, at least to some degree, the input prompt.

### Artificial Intelligence and Content Generation

A common workflow in AI-guided content creation involves generating a plurality of outputs for a given prompt, using a generative model. By way of example, Stable Diffusion, a latent text-to-image diffusion model, outputs multiple generated images for each text prompt, by default. As another example, an AI chatbot (e.g., ChatGPT) that leverages an LLM may be deployed to generate multiple responses to a single text prompt, such as a search query or chat input.

The outputs of a generative model for a given prompt may contain distinct content. A user may find that selected portions across multiple outputs are acceptable or preferred for their intended use of the generated content. In such cases, the user may wish to obtain a customized final content output that incorporates portions from different outputs associated with a given prompt. As a specific example, it may be desired to ensure that a combination of selected portions from an initial set of outputs of a generative model is included in the final content output.

A conventional approach for customizing AI-generated content consists of sequentially revising prompts for inputting to a generative model. Each revised prompt produces a new set of outputs, and a user may repeatedly revise input prompts until arriving at a preferred content output. This approach of iteratively generating new outputs may limit the user's ability to track historical outputs and preferred content data effectively. Furthermore, such an approach may result in an undesirably high number of API calls in sequence to get to an acceptable final content output. Thus, it would be advantageous to provide techniques for selectively combining portions from multiple outputs of a generative model, while also ensuring that the final content output is both coherent and responsive to an initial prompt, e.g., text description or chat input.

The present application discloses a solution that facilitates user-directed combinations of outputs of a generative/large language model. User selections and/or edits across one or more generated outputs of a generative model are stored in memory, and the selections/edits are provided back to the model, by means of an edited prompt, for combination into a final generation.

A generative model is initially requested to produce multiple outputs, each from the same text prompt. Upon generation, the multiple outputs are presented to the user via a graphical user interface. The outputs may be displayed concurrently (e.g., side-by-side) on the GUI or they may be viewed separately (e.g., sequentially) by navigating using the GUI.

The user selects any desired portions of individual ones of the outputs. In particular, the GUI enables the user to indicate portions that they wish to select from one or more of the outputs. The selected portions may represent the user's preferred or desired content. For a text output, the user may indicate (e.g., by highlighting) certain sections of the text. In some implementations, various defined portions of the text may be graphically indicated on the GUI, and the user may select one or more of the defined portions. For example, the disclosed system may process the text output, tokenize sentences or paragraphs from the text, and graphically represent the tokens via the GUI. The user may then select one or more of the tokens. In some cases, phrases or sentences may be used, rather than tokens, as the base unit of selection.

For an image output, the user may indicate (e.g., by circling a region of pixels) certain portions of the image. In some implementations, various features of the image may be graphically indicated on the GUI, and the user may select one or more of the features. For example, the system may perform object detection to identify and locate objects within the image, and graphically represent the objects via the GUI. The user may then select one or more of the identified objects. In other implementations, this process may be done in the opposite order, where the user may indicate a rough region (e.g., a circle) of the image and then the system may perform object detection to identify and locate objects within the circled region.

As the user selects the desired portions of the outputs, the selections may be displayed in a “sandbox” area of the GUI. The sandbox area may, for example, be a canvas or textbox that is dynamically updated to represent the user's selections across the multiple outputs. In particular, the sandbox area may be populated as the user progressively makes selections of desired portions from the outputs such that the totality of the selections portions is displayed in the sandbox area. Additionally, or alternatively, the sandbox area may be loaded with one or more of the outputs and the user may select portions of the outputs to remove from the sandbox area.

The locations of the selected text/images portions within the sandbox may depend on the locations of the text/image portions in the original outputs from which they are respectively selected. For example, a selected feature or object from a generated image output may be displayed at the same location within the sandbox canvas as it is in the original image. As another example, if a first sentence of a generated text output is selected, the selected sentence may be displayed at or near the top/front of the sandbox textbox.

The locations (absolute or relative) of the selected portions within the sandbox area may be optionally configurable by the user. The user can thus indicate desired locations of the selected portions in the final generation. For example, a user may change the location of a selected image portion (e.g., by drag-and-drop, voice commands, typed instructions, etc.) within a sandbox canvas. Selected text snippets in a sandbox textbox may appear as draggable objects that can be moved by the user. Other properties of the selected portions, such as scale, colors, language, etc., may be configurable by the user.

In some implementations, the system may enable the user to edit portions of the original outputs. For example, the user may replace or delete certain portions of a generated text output, and/or insert additional content into a portion of the generated text output (e.g., adding words in the middle of a selected sentence). As another example, the user may replace/delete certain portions of a generated image output, and/or add some pixels to the generated image output. The user edits may be received directly on the generations (e.g., using a painting tool (or copy-paste) for a generated image output or keyboard/cursor for a generated text output) or in the sandbox area (i.e., after selected portions are displayed in the sandbox area).

The system may optionally receive an indicator (e.g., numerical, voice, text, etc.) of adherence weight from the user. The adherence weight may represent the user's desired level of adherence to the content of the user selections and/or edits in future AI generations/revisions. For example, the user may use a numerical scale (e.g., scale of 1 to 10) to indicate the adherence weight. A value of 1 may represent strictest adherence (e.g., ensure that the user selections/edits are included in the final text or image output exactly as specified by the user) while a value of 10 may represent no adherence (i.e., take the user selections and edits as suggestions). Values between 1 and 10 may represent varying degrees of adherence (i.e., lower values may skew towards keeping the user selections/edits roughly as specified by the user, and their positions more or less the same as specified, while higher values may indicate more freedom for the model to deviate from the user selections/edits).

Upon receiving an indication from the user that they are finished making and/or configuring their selections and edits of the original outputs, the system is configured to modify the original prompt in accordance with the user selections/edits and the optional adherence weight. The modified prompt is then provided back to the model (e.g., LLM) for generation, and the returned output is presented as the final generation to the user.

In some implementations, the system may provide a preview of the final generation based on the user's selections/edits on an ongoing basis. The “preview” may itself be a partial output (e.g., based on a reduced prompt) or otherwise a complete output of the LLM. In particular, as the user makes their selections/edits of the original outputs, the system may continuously modify the original prompt on the basis of the selections/edits and provide the modified prompts to the model to obtain revised outputs. For example, each time the user makes a selection or edit, the GUI may be dynamically updated to display a new generation by the model that would be obtained based on an input of a prompt that is modified in accordance with the selection/edit.

To better illustrate additional details regarding the methods and systems of the present application, some concepts relevant to generative AI models, neural networks, and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train an ML model that is intended to classify images, the training dataset may be a collection of images. Training data may be annotated with ground truth labels (e.g., each data entry in the training dataset may be paired with a label), or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

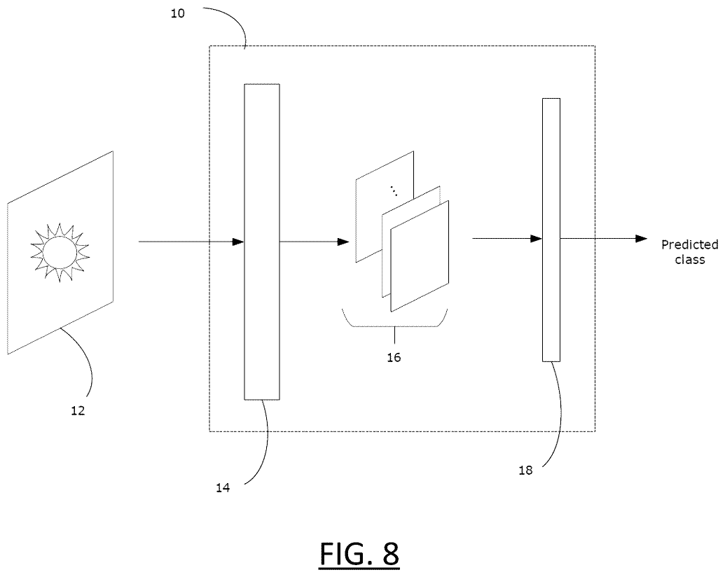

FIG. 8 is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to an ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

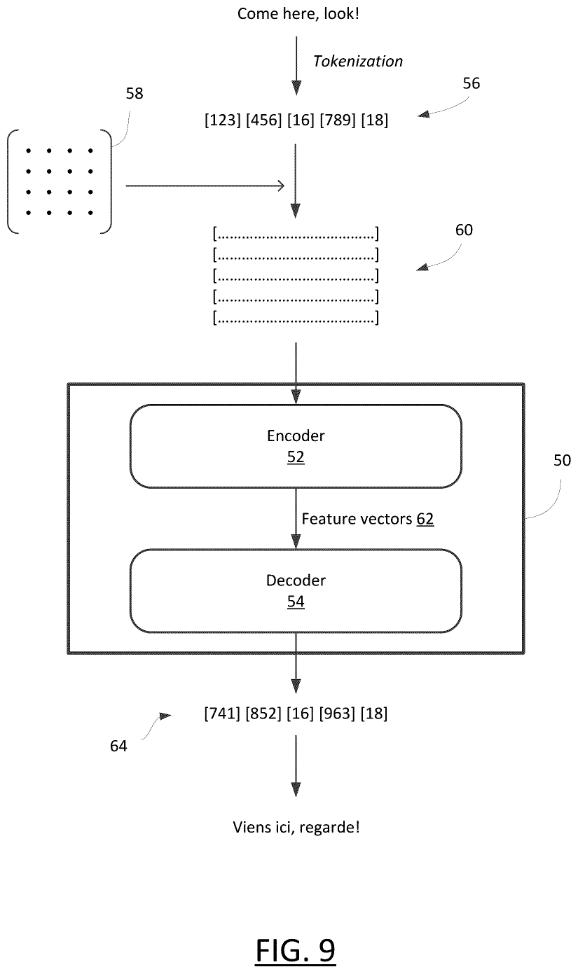

FIG. 9 is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here]. [.], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

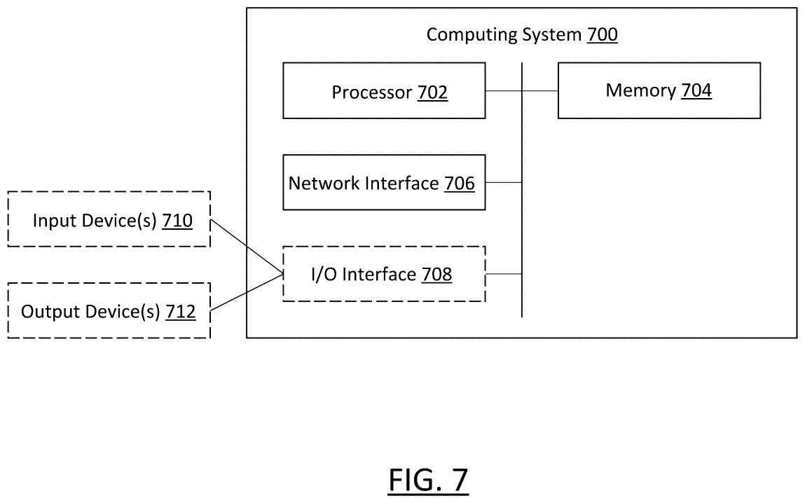

In FIG. 7, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 7 for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally, or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally, or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

FIG. 7 illustrates an example computing system 700, which may be used to implement examples of the present disclosure, such as a prompt generation engine to generate prompts to be provided as input to a language model such as an LLM. Additionally, or alternatively, one or more instances of the example computing system 700 may be employed to execute the LLM. For example, a plurality of instances of the example computing system 700 may cooperate to provide output using an LLM in manners as discussed above.

The example computing system 700 includes at least one processing unit, such as a processor 702, and at least one physical memory 704. The processor 702 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 704 may include a volatile or non-volatile memory (e.g., a flash memory, a random-access memory (RAM), and/or a read-only memory (ROM)). The memory 704 may store instructions for execution by the processor 702, to the computing system 700 to carry out examples of the methods, functionalities, systems and modules disclosed herein.

The computing system 700 may also include at least one network interface 706 for wired and/or wireless communications with an external system and/or network (e.g., an intranet, the Internet, a P2P network, a WAN and/or a LAN). A network interface may enable the computing system 700 to carry out communications (e.g., wireless communications) with systems external to the computing system 700, such as a language model residing on a remote system.

The computing system 700 may optionally include at least one input/output (I/O) interface 708, which may interface with optional input device(s) 710 and/or optional output device(s) 712. Input device(s) 710 may include, for example, buttons, a microphone, a touchscreen, a keyboard, etc. Output device(s) 712 may include, for example, a display, a speaker, etc. In this example, optional input device(s) 710 and optional output device(s) 712 are shown external to the computing system 700. In other examples, one or more of the input device(s) 710 and/or output device(s) 712 may be an internal component of the computing system 700.

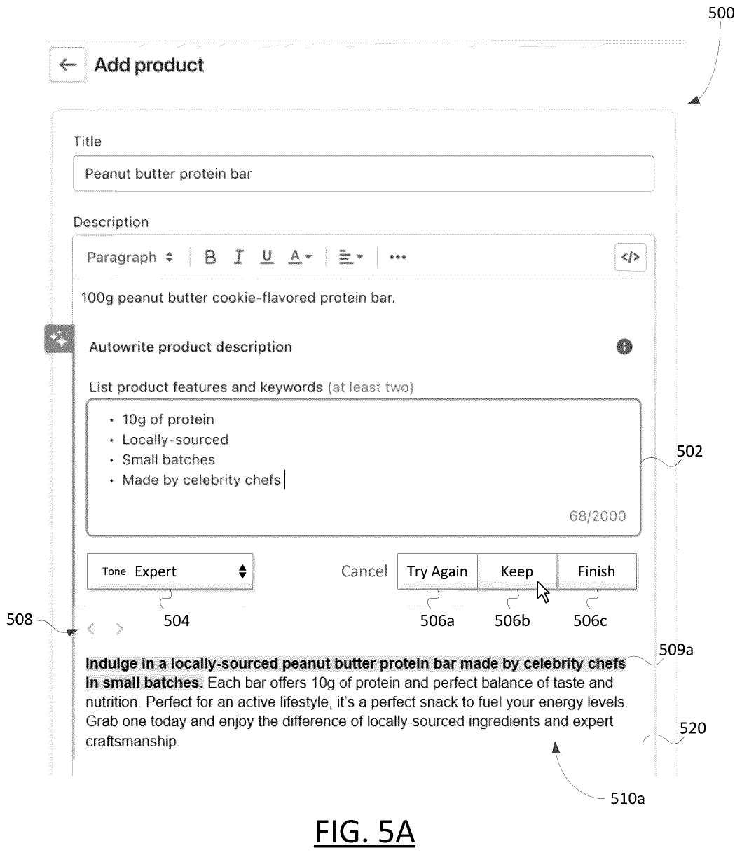

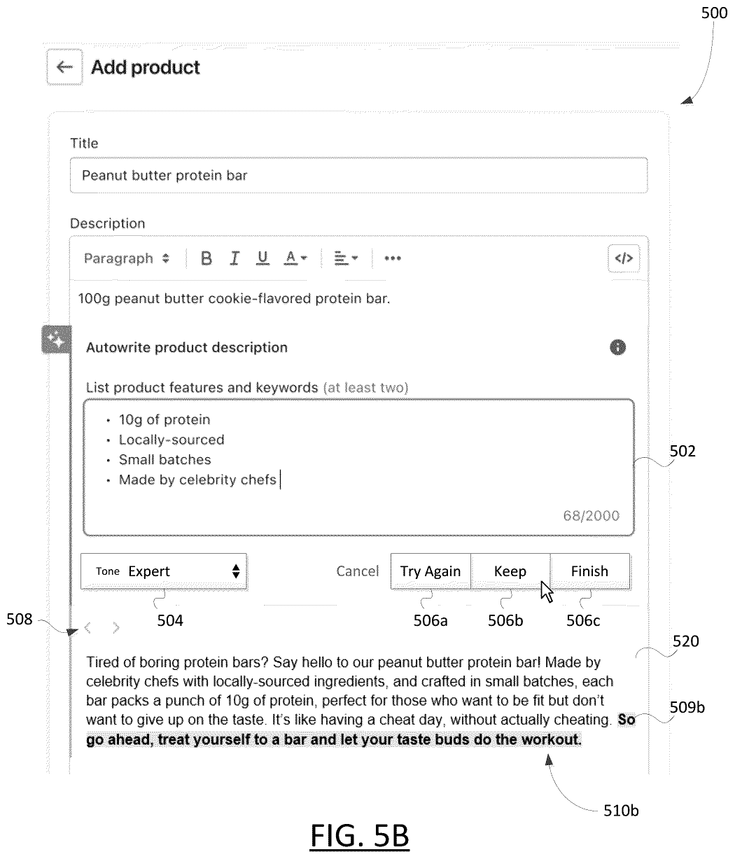

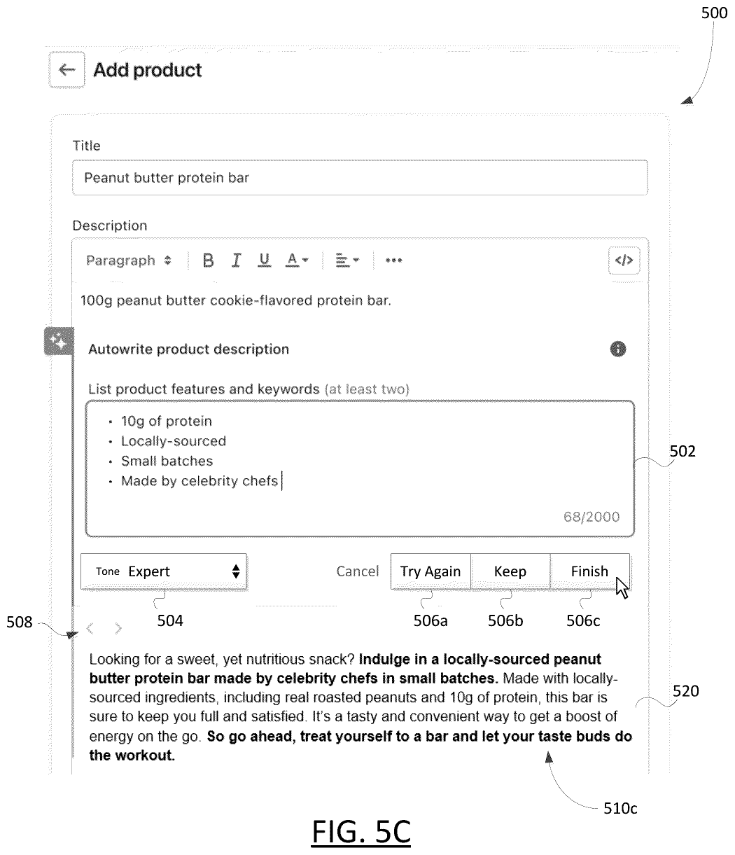

A computing system, such as the computing system 700 of FIG. 5, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

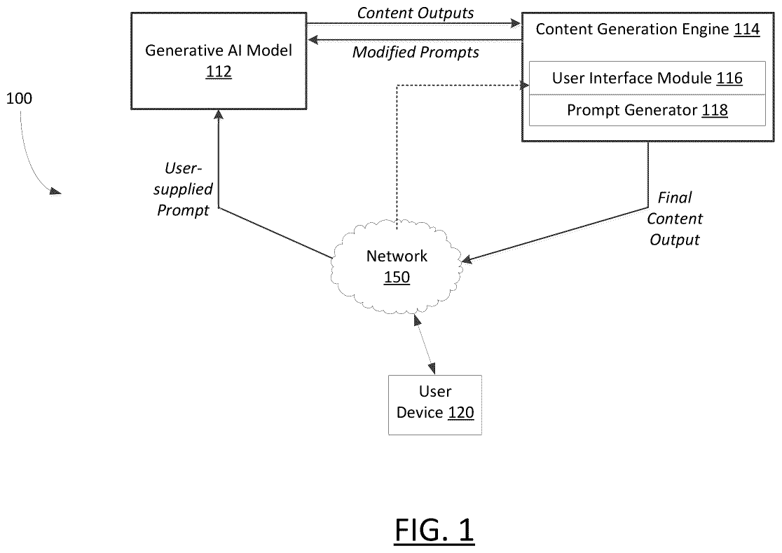

Reference is made to FIG. 1, which illustrates, in block diagram form, an example system 100 for implementing a content generation system. The system 100 may be implemented using one or more computing devices.

The system 100 includes a generative AI model 112, a content generation engine 114, a user interface module 116, and a prompt generator 118. The generative AI model 112 is an unsupervised or semi-supervised machine learning algorithm that has been trained using a set of training data content. The generative AI model 112 may be a transformer 50 (FIG. 7), as described above. The generative AI model 112 is configured to take an input prompt, and produces an output related to the input prompt. In some implementations, the generative AI model 112 may be a generative adversarial network.

An input prompt supplied by a user is received from the user device 120 via a network 150. In the context of content generation, the input prompt may be or include a command/request to generate content of a specific type. The input prompt may comprise text, images, audio, and/or other forms of unstructured data. More particularly, the input prompt may include a description of content that is requested to be generated by the generative AI model 112. By way of example, the input prompt may indicate various desired features, properties, or requirements for the requested content.

In some implementations, a user-supplied prompt may be processed by the system 100 to generate a suitable prompt for inputting to the generative AI model 112. In particular, a user-supplied prompt may be modified to produce the input prompt. For example, an input prompt may be generated by adjusting a user command or request to generate new content, in accordance with one or more defined constraints associated with the generative AI model 112. The constraints may, for example, relate to restrictions (e.g., character limits, content filters, etc.) on acceptable prompts for the generative AI model 112.

The content generation engine 114 receives outputs that are produced by the generative AI model 112. Each output comprises content that is generated based on an input prompt to the generative AI model 112. The input prompt may be an initial prompt that is supplied by a user, or it may be a modified prompt derived by the content generation engine 114 based on revising an initial prompt. The outputs of the generative AI model 112 may be provided to the content generation engine 114 for further processing and refining, for example, to obtain a final content output.

The content generation engine 114 enables users to customize AI-generated content. More particularly, the content generation engine 114 supports selectively combining portions from different outputs of the generative AI model 112. A user can select portions from one or more of the outputs that are desired to be included in a final content output. The user selections may be a representation of the user's preferences with regard to the generated content outputs. The content generation engine 114 is configured to receive the user selections and to ensure that the selections are reflected in instructions to the generative AI model 112 to generate new content. In this way, the generative AI model 112 can be guided toward desired behavior, i.e., generating content that incorporates selected portions from different outputs. In at least some implementations, the content generation engine 114 may iteratively perform the steps of receiving user selections of desired portions from outputs of the generative AI model, deriving modified input prompts based on the user selections, and providing the modified prompts to the generative AI model 112.

The generative AI model 112 may be accessed via a user interface, such as a chatbot (e.g., ChatGPT), that facilitates text-based conversation. The generative AI model 112 may provide chat-like outputs responsive to user-supplied prompts. For example, upon receiving input of an initial prompt from a user, the generative AI model 112 may produce one or more content outputs. The initial prompt may, for example, be a command to generate new content that specifies a content type (e.g., text, images, etc.) and minimum requirements for the generated content. The generative AI model 112 may produce a plurality of new content outputs that are based on the same initial prompt.

In at least some implementations, the content outputs produced by the generative AI model 112 may be accessed via a user interface for a content management system. In particular, a user interface module 116 may provide a graphical user interface for displaying the content outputs on user devices 120. The content outputs may be displayed in an output display area within the graphical user interface. A user may view the content outputs, either one-by-one or by suitable groupings. For example, the outputs from an iteration of content generation may be displayed one at a time, requiring the user to navigate through the outputs, or they may be displayed concurrently (e.g., displayed side-by-side) in the output display area.

The graphical user interface may additionally enable users to interact with the content outputs. In particular, users may input selections of portions from different content outputs using the graphical user interface. By way of example, for each content output associated with a given prompt, a user may indicate selections of one or more preferred portions from the content output using the graphical user interface. The selected portions may represent information that is desired by the user to be incorporated into a final content output. User input for indicating the selections may be received via an input device such as a mouse, pen, stylus, keyboard, microphone, and the like.

In some implementations, the graphical user interface may include a sandbox area. The sandbox area may be a region within the graphical user interface that is different from the output display area. As will be described in greater detail below, the sandbox area may comprise a canvas or textbox that is updated to represent a user's selections across multiple content outputs. In particular, the sandbox area may be gradually populated as the user makes selections of portions from different content outputs that are displayed in the output display area. In this way, when the user is finished making their selections, the totality of the selected portions may be displayed in the sandbox area.

The content generation engine 114 may be configured to send a final content output over the network 150 to the user device 120. If a user is satisfied with one of the outputs of the generative AI model 112, the user may flag the output as the final content output. The generative AI model 112 may iteratively produce new outputs based on modified prompts provided by the content generation engine 114, and the user may select an output from one of the iterations as the final content output. The content data of the final content output may then be transmitted to the user device 120 for display thereon.

In at least some implementations, the generative AI model 112 and the content generation engine 114 may be included in, or be accessed by, a content management system. A content management system may implement various functions of the generative AI model 112 and the content generation engine 114. For example, a back-end system associated with a content manager application may be configured to provide functionalities of a generative AI model and a content generation engine as described herein.

The network 150 is a computer network. In some implementations, the network 150 may be an internetwork such as may be formed of one or more interconnected computer networks. For example, the network 150 may be or may include an Ethernet network, an asynchronous transfer mode (ATM) network, a wireless network, or the like.

In some example implementations, the content generation engine 114 may be integrated as a component of an e-commerce platform. That is, an e-commerce platform may be configured to implement example embodiments of the content generation engine 114. In particular, the subject matter of the present application, including example methods for customizing AI-generated content, may be employed in the specific context of e-commerce. For example, the content generation engine 114 may be adapted for generating product-related content (e.g., promotional images, photos, or text, product descriptions, etc.) associated with products that are offered on an e-commerce platform.

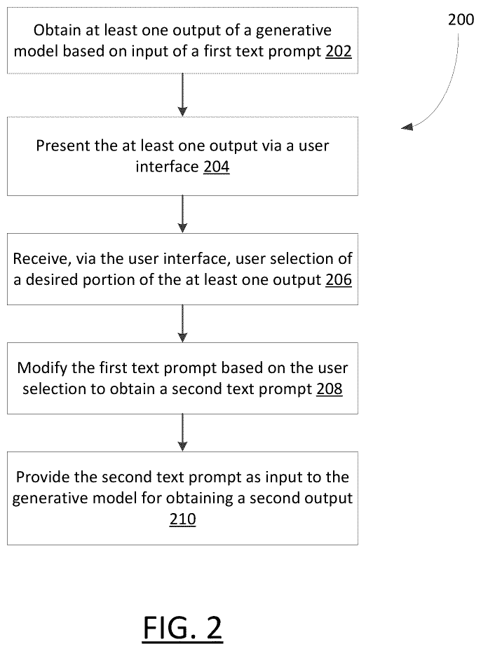

Reference is now made to FIG. 2, which shows, in flowchart form, an example method 200 for customized content creation using a generative AI model. The method 200 may be implemented, at least in part, on a computing system, such as the system 100 of FIG. 1.

The method 200 may include training a generative model, such as a text-to-image model or a large language model (LLM), using a training data set. In some implementations, the generative model may be trained, or fine-tuned, using domain-specific training data. For example, in an e-commerce context, the generative model may be fed data comprising product information (such as product categories, attributes, descriptions, images, etc.), customer queries and corresponding responses (e.g., search results), e-commerce service offerings, etc.

Once the generative model is trained and deployed, the computing system obtains at least one output of the generative model based on input of a first text prompt, in operation 202. The first text prompt is an initial prompt that is supplied by the user to the generative model. In particular, the first text prompt may be or include a command/request to generate new content. For example, the first text prompt may include a description of content that is requested to be generated. Additionally, or alternatively, the first text prompt may indicate certain features, properties, or requirements for the requested content. The first text prompt may be provided directly by a user, or it may be generated by the computing system based on user-inputted data (e.g., input text, image upload, etc.). A user may, for example, type in the entirety of the first text prompt in an input field of a graphical user interface. Alternatively, the user may provide one or more keywords in an input field that includes predefined template language for inclusion in the first text prompt.

In some implementations, the at least one output comprises multiple different content outputs that are produced by the generative model, based on the same text prompt. That is, the computing system may obtain a plurality of content outputs using the first text prompt. The content outputs may be generated from a single command to produce multiple outputs, or they may be generated over multiple commands to produce at least one output. For each command, the computing system may invoke an application programming interface (API) call for submitting a request to an API associated with the generative model to generate new content. The API call may include, at least, the first text prompt for inputting to the generative model.

The computing system presents the at least one output of the generative model via a user interface, in operation 204. More particularly, the at least one output may be displayed on a graphical user interface associated with a content management (or related) system. The graphical user interface may be provided by the computing system to a user device for displaying thereon. For example, a user interface module (such as the module 116 shown in FIG. 1) of the computing system may be adapted to generate and present the graphical user interface on a user device.

The outputs may be displayed one-by-one or by suitable groupings on the graphical user interface. A user may navigate the graphical user interface on their device in order to access the contents of the at least one output. For example, a user may interact with one or more navigational user interface elements on a graphical user interface to browse through a plurality of outputs of the generative model. In at least some implementations, the graphical user interface may include an output display area that is configured to display the at least one output. The output display area may, for example, comprise one or more regions of the graphical user interface in which text and/or image data associated with the at least one output can be displayed.

The user interface may allow users to interact with the at least one output. In particular, users may select, edit, delete, replace, or otherwise manipulate one or more portions of the outputs that are presented in the user interface. In operation 206, the computing system receives, via the user interface, user selection of a portion of the at least one output. The selected portion may represent preferred element(s) of the at least one output that the user wishes to incorporate into a final content output. The user selection can thus serve to indicate elements of the at least one output that are desired to be represented and/or wholly retained in subsequently generated outputs of the generative model.

In at least some implementations, the user selection may be input directly via the user interface. For example, in the case of an output that contains text, the user may select certain words or sentences, as displayed on the user interface, by highlighting text corresponding to the words/sentences. As another example, in the case of an output that contains an image, the user may select (e.g., by drawing or otherwise indicating boundaries around) regions or pixels of the image corresponding to the user's desired portions on the user interface. The selections can be made using an input device such as a mouse, pen, stylus, keyboard, etc. Additionally, or alternatively, the user selection may be received by the computing system via indirect input mechanisms such as typed responses to a prompt for selection, voice input (i.e., using speech recognition), and the like.

The user selection may comprise information that directly identifies a specific portion of the at least one output. For example, in the case of a text output, the user selection may include the entirety of the text of a particular sentence. The user may, for example, highlight an entire sentence and indicate that the highlighted sentence is part of the user selection. In the case of an image output, the user selection may comprise identifiers of one or more objects which are depicted in the output. Alternatively, the user selection may comprise indirect identifying information. For example, the user may specify “second sentence of third paragraph of the output” as their selection, thereby providing information (i.e., structural unit of text, relative location of the selection within the output) that can be used to locate the user-selected portion.

The computing system automatically modifies the first text prompt based on the user selection to obtain a second text prompt, in operation 208. The second text prompt may be an input prompt to the generative model for a subsequent iteration of content generation. That is, the generative model may produce new content based on the second text prompt. The first text prompt, e.g., the initial prompt supplied by the user, may be modified so that the second text prompt reflects the user's preferences as indicated by the user-selected portions from the at least one output. In particular, the second text prompt may retain the original intent and context associated with the first text prompt while also representing preference data supplied by the user through their selection(s).

In some implementations, the second text prompt may be generated by adding, to the first text prompt, supplementary text that describes the selection(s). The supplementary text may comprise text describing properties of the user-selected portions. By way of example, the supplementary text may include text specifying one or more of a content type, location (e.g., absolute and/or relative location), size, etc. for each of the user-selected portions. The properties may be automatically determined by the computing system, for example, based on parsing the outputs and the user-selected portions using text and/or image processing algorithms.

Additionally, or alternatively, the supplementary text may comprise text describing information that is to be excluded in subsequent outputs. More particularly, the second text prompt may describe portions of the at least one output that are not selected by the user as content to exclude in subsequent iterations of content generation. This description of exclusionary information may be appended to the first text prompt to generate the second text prompt.

In operation 210, the computing system provides the second text prompt as input to the generative model for obtaining one or more second outputs. The second output comprises new content that is produced by the generative model in a subsequent iteration of content generation based on the second text prompt. In particular, the second output may be an output of the generative model that includes representations of user-selected portions from the outputs of preceding iteration(s) of content generation. The second output data may be presented to the user via the user interface. In some implementations, the computing system may prompt the user to confirm the second output data as the final content output or to make further selections of portions from the second output(s). This process of iteratively modifying input prompts to the generative model and producing new content outputs may be continued until the user either flags one of the outputs as the final content output or manually terminates the process.

In at least some implementations, the user interface may include a sandbox region for graphically representing the user selection(s). The sandbox region is an area of the user interface, such as a canvas or textbook, that is distinct from the output display area. The computing system may update the sandbox region to include portions of different outputs that are selected by the user. In particular, the sandbox region may be populated dynamically as the user selects portions of outputs that are displayed in the output display area.

The locations of the selected portions within the sandbox region may depend on the locations of those portions in the original outputs from which they are respectively selected. For example, a selected feature or object from a generated image output may be displayed at the same absolute location within the sandbox region as it is in the original output. As another example, if a first sentence of a generated text output is selected, the selected sentence may be displayed at the same relative location (i.e., at or near the top/front) of the sandbox textbox.

The computing system may receive, via the user interface, input for changing a property of a selected portion of the at least one output in the sandbox region. The property of the selected portion may comprise, for example, location, scale, color, language, or the like. Responsive to receiving such input, the computing system may update the user interface to graphically represent the requested change of the property in the sandbox region.

By way of example, the locations (absolute or relative) of the selected portions within the sandbox region may be configurable by the user. The user can indicate desired locations of the selected portions in the final content output. For example, a user may change the location of a selected image portion (e.g., by drag-and-drop, voice commands, typed instructions, etc.) within a sandbox canvas. Selected text snippets in a sandbox textbox may appear as draggable objects that can be moved by the user.

In some implementations, the user may provide an indicator (e.g., numerical, voice, text, etc.) of adherence weight. The adherence weight may represent the user's desired level of adherence, by the generative model, to the user selections and/or edits in subsequent iterations of content generation. For example, the user may use a numerical scale (e.g., scale of 1 to 10) to indicate the adherence weight. A value of 1 may represent strictest adherence (e.g., ensure that the user selections/edits are included in the final text or image output exactly as specified by the user) while a value of 10 may represent no adherence (i.e., take the user selections and edits as suggestions). Values between 1 and 10 may represent varying degrees of adherence (i.e., lower values may skew towards keeping the user selections/edits roughly as specified by the user, and their positions more or less the same as specified, while higher values may indicate more freedom for the model to deviate from the user selections/edits). Other scales may be used by the user for indicating adherence weight. Both the user-specified adherence weight value and the second text prompt may be input to the generative model for obtaining the second output(s).

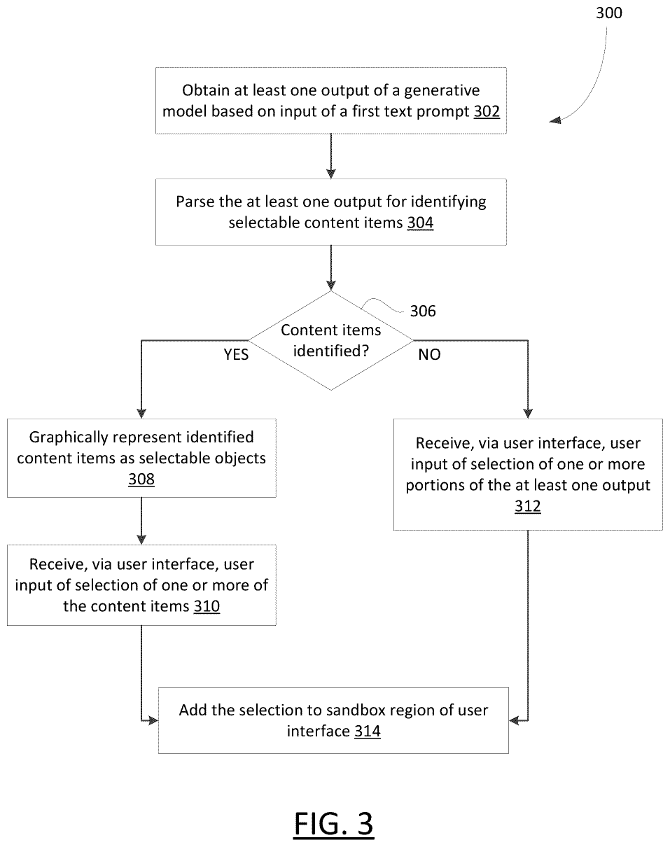

Reference is now made to FIG. 3, which shows, in flowchart form, an example method 300 for providing a user interface for customizing AI-generated content. The method 300 may be implemented, at least in part, on a computing system, such as the system 100 of FIG. 1. The operations of method 300 may be performed in addition to, or as alternatives of, one or more operations of method 200.

The method 300 may include training a generative model, such as a text-to-image model or a large language model (LLM), using a training data set. Once the generative model is trained and deployed, the computing system obtains at least one output of a generative model based on input of a first text prompt, in operation 302. The first text prompt may be an initial prompt that is supplied by the user to the generative model. In particular, the first text prompt may be or include a command/request to generate new content. The at least one output may be displayed in a graphical user interface, for example, in an output display area.

In operation 304, the computing system parses the at least one output for identifying selectable content items. Content items may include defined objects, units of content, etc. which may be independently identified in the output. In the context of text output, the computing system may perform processing of text associated with the at least one output. By way of example, the computing system may tokenize the text to obtain a list of one or more tokens (e.g., words) associated with the at least one output. As another example, if the at least one output comprises image data, the computing system may perform image segmentation and/or object detection to identify objects in an image associated with the at least one output. Based on processing the image data, the computing system may identify one or more objects in the image.

If content items are identified in the at least one output (operation 306) based on the parsing, the computing system graphically represents the identified content items as independently selectable and/or editable items, in operation 308. For example, the content items may be associated with user interface elements that can be selected (and/or edited) by the user using an input device such as a mouse, stylus, and the like.

The computing system then receives, via the user interface, user input of selection of one or more of the content items (operation 310). For example, the at least one output may comprise a text output, and the user selection may include at least one selectable token associated with the text of the at least one output. As another example, the at least one output may comprise image data, and the user selection may include one or more selectable objects that are identified in an image associated with the at least one output.

If, on the other hand, no content items are identified in the at least one output, the computing system receives, via the user interface, user input of selection of one or more portions of the at least one output, in operation 312. For example, in the case of an output that contains text, the user may select certain words or sentences, as displayed on the user interface, by highlighting text corresponding to the words/sentences. As another example, in the case of an output that contains an image, the user may select (e.g., by drawing or otherwise indicating boundaries around) regions or pixels of the image corresponding to the user's desired portions on the user interface. The selections can be made using an input device such as a mouse, pen, stylus, keyboard, etc. Additionally, or alternatively, the user selection may be received by the computing system via indirect input mechanisms such as typed responses to a prompt for selection, voice input (i.e., using speech recognition), and the like.

In operation 314, the computing system adds the user selection to a sandbox region of the graphical user interface. In particular, the selections made by the user in an output display arca are also caused to be displayed in the sandbox region. The selections may, for example, be displayed in the sandbox region in real-time as the user interacts with (e.g., selects, edits, etc.) the at least one output.

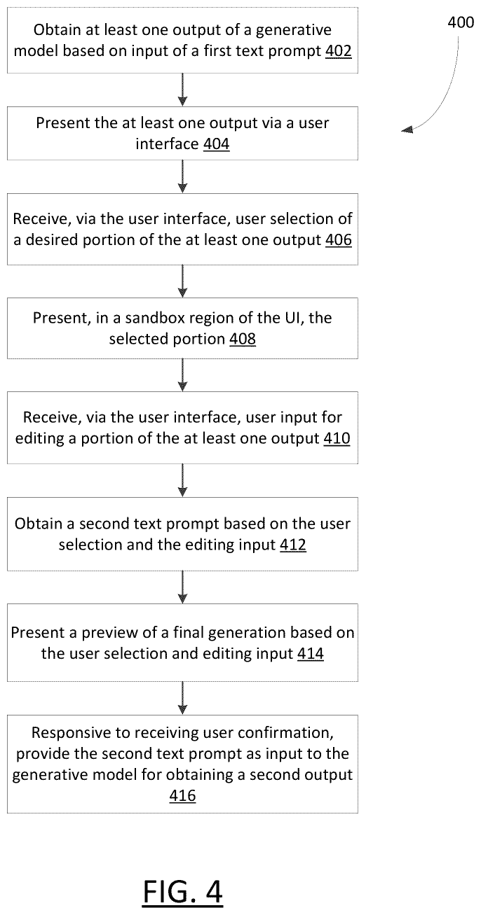

Reference is now made to FIG. 4, which shows, in flowchart form, another example method 400 for customized content creation using a generative AI model. The method 400 may be implemented, at least in part, on a computing system, such as the system 100 of FIG. 1. The operations of method 400 may be performed in addition to, or as alternatives of, one or more operations of methods 200 and 300.

The method 400 may include training a generative model, such as a text-to-image model or a large language model (LLM), using a training data set. Once the generative model is trained and deployed, the computing system obtains at least one output of a generative model based on input of a first text prompt, in operation 402. The first text prompt may be an initial prompt that is supplied by the user to the generative model. In particular, the first text prompt may be or include a command/request to generate new content. The at least one output may be displayed in a graphical user interface, for example, in an output display area.

In operation 404, the computing system presents the at least one output via a user interface. For example, the at least one output may be displayed in an output display area of a graphical user interface. The computing system then receives, via the user interface, user selections of desired portions of the at least one output, in operation 406. As described above with reference to FIGS. 3 and 4, the user selections may comprise selectable content items that are automatically identified in the at least one output and/or user-selected portions of the at least one output.

The computing system presents, in a sandbox region of the user interface, the user selections, in operation 408. In particular, the sandbox region may be configured to display the totality of content selections made by the user from the at least one output.

In addition to selecting desired portions from outputs of the generative model, the user may wish to edit or change certain elements of the selected portions. In operation 410, the computing system receives, via the user interface, user input for editing and/or changing a portion of the at least one output. The edits/changes may be used to indicate the user's preferences with respect to the content of the selected portions. User input for editing/changing may comprise at least one of: deletion of a portion of an output, replacement of a portion of an output, or addition of text or image. An input device, such as a mouse, stylus, or the like, may be used to provide the input of edits/changes. The user input may be received directly on the user interface, for example, in the output display area or the sandbox region.

In operation 412, the computing system obtains a second text prompt based on the user selection and the editing input. In particular, the second text prompt may be obtained by modifying the first text prompt to reflect both the user selection and the user edits. The first text prompt, i.e., the initial prompt supplied by the user, may be modified so that the second text prompt reflects the user's preferences as indicated by the user selection and the user edits of the at least one output. In particular, the second text prompt may retain the original intent and context associated with the first text prompt while also representing preference data supplied by the user through the selections and edits. The second text prompt may, in some implementations, include text describing the user selections/edits. For example, the descriptive text may indicate the portion of text/image that is edited, type of edit(s) (e.g., re-sizing, color change, changing position, etc.), and the like. The descriptive text may be appended to the end of, or otherwise integrated with, the first text prompt.

In some implementations, the computing system presents a preview of a final content output based on the user selection and editing input (operation 414). That is, a preview of a subsequent output of the generative model that may be produced based on an input prompt that reflects the user selection and the user edits may be presented to the user. The preview may, for example, be displayed in real-time via the graphical user interface (e.g., in an area that is distinct from the output display area and the sandbox region).

In operation 416, responsive to receiving user confirmation, the computing system provides the second text prompt as input to the generative model for obtaining a second output. Once the user has finished editing, the user may provide an indication for confirming that desired changes have been made to selected portions of the at least one output. The computing system may then request for the generative model to produce a second output based on the second text prompt.

Reference is now made to FIGS. 5A to 5C, which an example page 500 of a graphical user interface that supports auto-generation of customized text content, in accordance with example embodiments. In particular, the example page 500 may enable customized content creation as described above with reference to methods 200 to 400. The example page 500 may be displayed, for example, as part of an editor interface for editing a merchant website.

As shown in FIG. 5A, the example page 500 may include input fields for, at least, a product title and a description of the product. The example page 500 supports auto-generation of a product description. A user can provide a list of product features and keywords into the input field 502. A product description may be automatically generated based on the user-inputted product features and keywords. More particularly, the user-inputted data may be included in a first input prompt, which is then provided to a generative AI model. The output of the model, i.e., a generated product description, may be displayed in the output display area 520. FIG. 5A shows a first text output 510a that is generated based on information inputted in the input field 502. A different product description may be generated if the user selects the “Try Again” button 506a. The user can change the language tone/style for the product description using the drop-down menu 504.

The user can indicate preference for a certain portion of a generated output by selecting the portion in the output display area 520. For example, the user can select/highlight text within the first text output 510a. The selected text 509a can be stored for inclusion in a final text output by selecting the “Keep” button 506b. The stored data for preferred text portions may include the actual selected text, relative location of the selection, edits to the selected text (if any), and the like. By generating new product descriptions (i.e., 510a, 510b, etc.) and selecting preferred text portions (i.e., 509a, 509b, etc.) from each of those descriptions, the user can customize what the final text output will look like. The arrows 508 can be used to navigate to different text outputs within the output display area 520. That is, the user can flip through the different generated descriptions using the arrows 508.

If the “Finish” button 506c is selected at any time, a final text output 510c may be generated. The final text output 510c is an output that comprises the selected text portions from previously generated descriptions. A second input prompt may be obtained by modifying the first input prompt, and the second input prompt is provided to the generative AI model as part of a request to generated the final text output 510c. The second input prompt may include, at least, a description of the user selections from and/or edits of the previously generated descriptions.

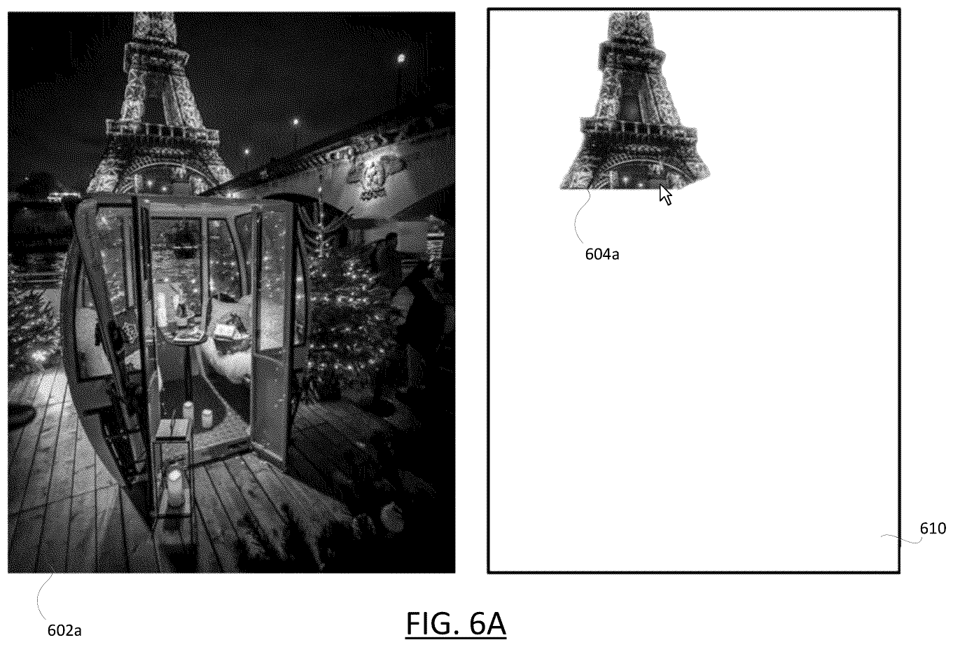

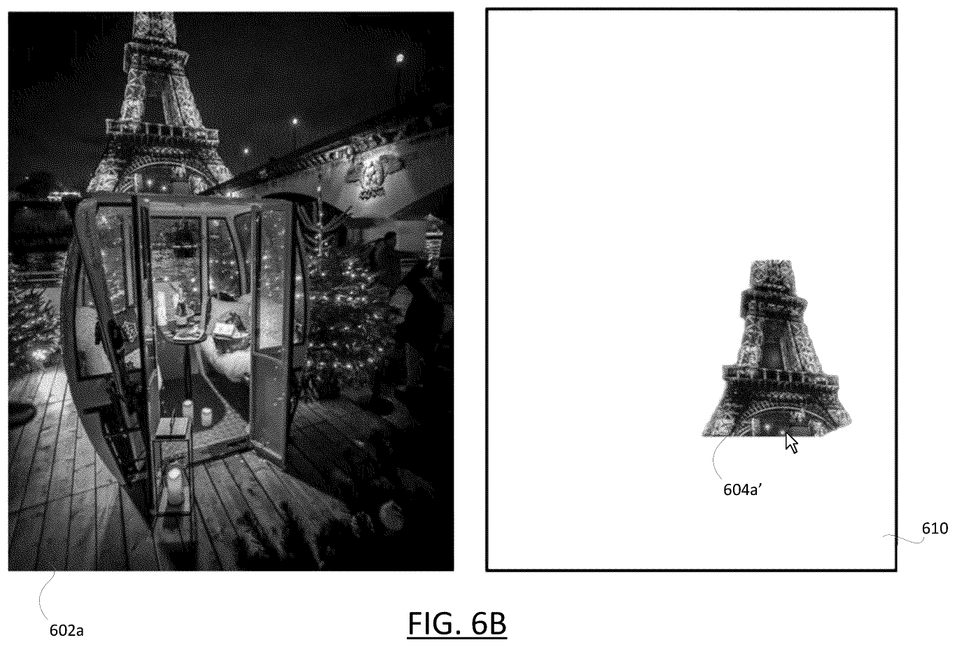

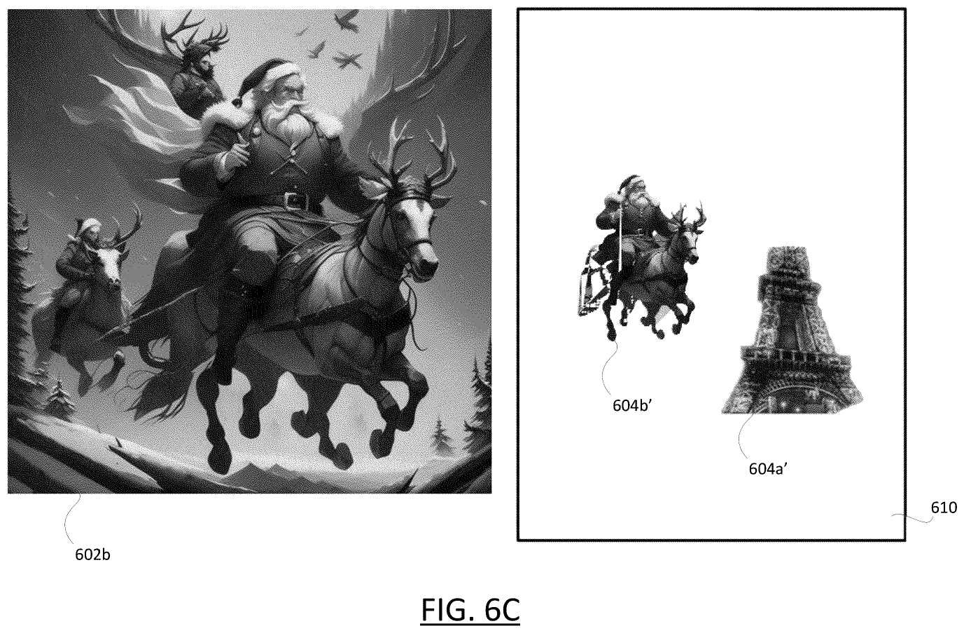

Reference is now made to FIGS. 6A to 6C, which illustrate use of a sandbox 610 for generating customized images, in accordance with example embodiments described above with reference to methods 200 to 400. For each image (i.e., 602a, 602b, etc.) that is output by a generative AI model, a user can select preferred portions of the image (e.g., 604a) which are desired to be included in a final output image. The preferred portions may comprise, for example, a selected object, region, or collection of pixels in a generated image. The sandbox 610, such as a canvas illustrated in FIGS. 6A to 6C, may be used to track the user selections of preferred portions across multiple different image outputs.

Further, a user can edit one or more of the selected portions in the sandbox 610. By editing a selected portion in the sandbox 610, the user can indicate their preference of what the final image output will look like. In FIG. 6B, the object 604a′ represents a change in position of the object 604a that is selected from the output image 602a. The user can, for example, drag and drop the object 604a within the sandbox 610 to change its position. This edit may represent the user's preference for the position of the object 604a′ in the final image output. FIG. 6C shows an object 604b′ that is selected from the output image 602b, and that has been resized and repositioned in the sandbox 610.

### IMPLEMENTATIONS

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some implementations, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g., Long-Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method, comprising:
obtaining at least one output of a generative model based on input of a first text prompt;
presenting the at least one output via a user interface;
receiving, via the user interface, user selection of a desired portion of the at least one output;
modifying the first text prompt based on the user selection to obtain a second text prompt; and
providing the second text prompt as input to the generative model for obtaining a second output.

2. The method of claim 1, wherein the at least one output comprises multiple different outputs generated via the generative model based on a same text prompt.

3. The method of claim 1, wherein the generative model comprises one of a text-to-image model or a large language model (LLM).

4. The method of claim 1, wherein receiving the user selection of a desired portion comprises:
performing text processing of a text output for obtaining a list of one or more tokens;
presenting the one or more tokens via the user interface; and
receiving selection of at least one of the one or more tokens.

5. The method of claim 1, wherein receiving the user selection of a desired portion comprises:
performing object detection of an image output for identifying one or more objects;
graphically representing the one or more objects via the user interface; and
receiving selection of at least one of the one or more objects.

6. The method of claim 1, further comprising displaying, via the user interface, a sandbox region for graphically representing the user selection, wherein the sandbox region is dynamically updated based on selections of desired portions across multiple different outputs.

7. The method of claim 6, further comprising:
receiving, via the user interface, input for changing a property of a selected desired portion of the at least one output in the sandbox region; and
updating the user interface to represent the inputted change of the property.

8. The method of claim 7, wherein the property of the selected desired portion comprises one of location, scale, color, or language.

9. The method of claim 1, further comprising receiving, via the user interface, input of user edits of the at least one output and wherein the second text prompt is obtained by modifying the first text prompt based on the user selection and the user edits.

10. The method of claim 9, wherein the user edits comprise at least one of: deletion of a portion of an output; replacement of a portion of an output; or addition of text or image.

11. The method of claim 1, further comprising:
receiving user input of an adherence weight value representing a desired level of adherence to the user selection, wherein the second text prompt and the adherence weight value are provided as input to the generative model for obtaining the second output.

12. A computing system, comprising:
a processor; and
a memory coupled to the processor, the memory storing computer-executable instructions that, when executed by the processor, are to cause the processor to:
obtain at least one output of a generative model based on input of a first text prompt;
present the at least one output via a user interface;
receive, via the user interface, user selection of a desired portion of the at least one output;
modify the first text prompt based on the user selection to obtain a second text prompt; and
provide the second text prompt as input to the generative model for obtaining a second output.

13. The computing system of claim 12, wherein the at least one output comprises multiple different outputs generated via the generative model based on a same text prompt.

14. The computing system of claim 12, wherein the generative model comprises one of a text-to-image model or a large language model (LLM).

15. The computing system of claim 12, wherein receiving the user selection of a desired portion comprises:
performing text processing of a text output for obtaining a list of one or more tokens;
presenting the one or more tokens via the user interface; and
receiving selection of at least one of the one or more tokens.

16. The computing system of claim 12, wherein receiving the user selection of a desired portion comprises:
performing object detection of an image output for identifying one or more objects;
graphically representing the one or more objects via the user interface; and
receiving selection of at least one of the one or more objects.

17. The computing system of claim 12, wherein the instructions, when executed, are to further cause the processor to display, via the user interface, a sandbox region for graphically representing the user selection, wherein the sandbox region is dynamically updated based on selections of desired portions across multiple different outputs.

18. The computing system of claim 12, wherein the instructions, when executed, are to further cause the processor to receive, via the user interface, input of user edits of the at least one output and wherein the second text prompt is obtained by modifying the first text prompt based on the user selection and the user edits.

19. The computing system of claim 12, wherein the instructions, when executed, are to further cause the processor to receive user input of an adherence weight value representing a desired level of adherence to the user selection, wherein the second text prompt and the adherence weight value are provided as input to the generative model for obtaining the second output

20. A non-transitory processor-readable medium storing processor-executable instructions that, when executed by a processor, are to cause the processor to:
obtain at least one output of a generative model based on input of a first text prompt;
present the at least one output via a user interface;
receive, via the user interface, user selection of a desired portion of the at least one output;
modify the first text prompt based on the user selection to obtain a second text prompt; and
provide the second text prompt as input to the generative model for obtaining a second output.
